(19) United States
(12) Patent Application Publication
(10) Pub. No.: US 2023/0054750 A1
(43) Pub. Date: Feb. 23, 2023

(54) ELECTRONIC DEVICE PROTECTIVE SHELL WITH LIGHT SUPPLEMENTING LAMP

(71) Applicant: SHENZHEN BESTVIEW ELECTRONIC CO., LTD, Shenzhen (CN)

(72) Inventor: Qinyuan Chen, Shenzhen (CN)

(21) Appl. No.: 17/536,077

(22) Filed: Nov. 28, 2021

(30) Foreign Application Priority Data
Aug. 23, 2021 (CN) 2021219739862

(51) Int. Cl. G03B 15/02; H05B 47/19

(52) U.S. Cl. CPC G03B 15/02; H05B 47/19; G03B 2215/0517; G03B 2215/056

(57) ABSTRACT

The present disclosure provides an electronic device protective shell with light supplementing lamp, including a shell and a light-emitting mechanism. The shell is configured to accommodate an electronic device. The shell includes a bottom plate, and the bottom plate is disposed on a back side of the shell. The light-emitting mechanism is disposed in the shell. The light-emitting mechanism includes a light source assembly, a battery and an electric control module. The light source assembly and the battery are respectively electrically connected to the electric control module. The light source assembly includes lamp beads and a lamp plate, and a part of the bottom plate corresponding to the lamp plate is a light-transmitting plate. The present disclosure is an electronic device protective shell which may directly and intelligently supplement light for an electronic device.

### TECHNICAL FIELD

The present disclosure relates to a field of electronic device protective shells, and in particular to an electronic device protective shell with light supplementing lamp.

### BACKGROUND

electronic device is an indispensable electronic product in life of people. Generally, a holder of the electronic device will purchase a protective shell to protect the electronic device to prevent the electronic device from being broken. Moreover, the electronic device has a plurality of powerful functions, where a photography function is relatively frequently used in the plurality of functions, but for some environments with poor lighting, a built-in flash lamp of the electronic device cannot meet requirements of the environments with poor lighting.

### SUMMARY

In order to solve problems mentioned in the background, it is necessary to provide an electronic device protective shell capable of directly and intelligently supplementing light for an electronic device.

The present disclosure provides an electronic device protective shell with light supplementing lamp, includes a shell and a light-emitting mechanism. The shell is configured to accommodate an electronic device, the shell includes a bottom plate, and the bottom plate is disposed on a back side of the shell. The light-emitting mechanism includes a light source assembly, a battery, and an electric control module, and the light-emitting mechanism is disposed in the shell. The light source assembly and the battery are respectively and electrically connected to the electric control module. The light source assembly includes lamp beads and a lamp plate, and a part, corresponding to the lamp plate, of the bottom plate is a light-transmitting plate.

Furthermore, a PC protective sheet is disposed on a surface of the lamp plate and a surface of the battery, and the PC protective sheet is bonded and fixed through a back adhesive.

Furthermore, the lamp beads are combinations of high color rendering index (CRI) RGB lamp beads and cooling and heating lamp beads.

Furthermore, a wireless module is disposed in the electric control module, and the wireless module is configured to be wirelessly connected with the electronic device to control a switch and/or a light-emitting mode and/or a light-emitting color temperature of the lamp beads through the electronic device.

Furthermore, the light-emitting mode includes a light-emitting color and a light-emitting brightness.

Furthermore, the electric control module is located on a side edge of a camera through hole of the shell, the lamp beads are disposed in a middle of the shell, and the battery is disposed at a lower position of the shell.

Furthermore, the lamp beads are arranged in a plurality of parallel arrays.

Compared with prior art, the present disclosure has following beneficial effects as following. A large area of the lamp beads are disposed on the protective shell, a part, corresponding to the lamp beads, of the bottom plate of the protective shell is a light-transmitting plate, and light emitted by the lamp beads passes through the light-transmitting plate, so that the supplement light is emitted from a back of the protective shell. When a camera of the electronic device is started to photograph, a light supplementing lamp may be turned on to supplement light for the electronic device during photographing, so that photographing brightness and photographing effect are improved.

### BRIEF DESCRIPTION OF DRAWINGS

FIG. 1 is an exploded schematic diagram of a specific embodiment of an electronic device protective shell with light supplementing lamp of the present disclosure.

### DETAILED DESCRIPTION

Technical solutions in embodiments of the present disclosure are clearly and completely described below with reference to accompanying drawings in the embodiments of the present disclosure. Obviously, the described embodiments are only a part of the embodiments of the present disclosure, rather than all of the embodiments. Based on the embodiments of the present disclosure, all other embodiments obtained by a person with ordinary skills in art without creative efforts shall fall within a protection scope of the present disclosure. It is to be understood that drawings are merely configured for reference and illustration, and the drawings are not configured to limit the present disclosure. Connection relationship shown in the drawings is merely for a convenience of clear description, and the connection relationship does not limit a connection mode.

It should be noted that when a component is considered to be “connected” to another component, the component may be directly connected to another component, or a centering component may be present at the same time. Unless otherwise defined, all technical and scientific terms used herein have same meaning as commonly understood by the person with ordinary skill in the art to which the present disclosure belongs. It should further be noted that terms “mounted”, “communicated”, and “connected” are to be understood broadly, for example, the terms may be fixedly connected or detachably connected or integrally connected. The terms may be mechanically connected or electrically connected, and the terms may further be in communication with interior of two elements. For the person with ordinary skill in the art, specific meanings of above terms in the present disclosure may be understood according to specific situations. Terminology used herein in specification of the present disclosure is for purpose of describing particular embodiments merely and the terminology is not intended to limit the present disclosure.

It should further be noted that, in description of the present disclosure, terms “center”, “upper”, “lower”, “left”, “right”, “vertical”, “horizontal”, “inner”, “outer” are intended to describe the present disclosure and simplified description based on an orientation or a positional relationship shown in the drawings. The terms are rather than indicating or implying that an indicated device or an element has to have a specific orientation, is constructed and operated in a specific orientation, and therefore the terms should not be construed as limiting the present disclosure. In addition, terms “first”, “second”, and “third” are merely configured for descriptive purposes and the terms are not to be construed as indicating or implying relative importance.

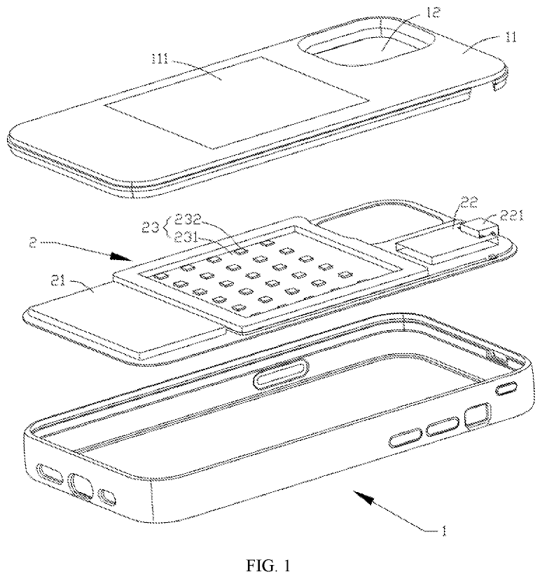

Referring to FIG. 1, the present disclosure provides an electronic device protective shell with light supplementing lamp. A specific implementation is as follows. The electronic device protective shell with light supplementing lamp includes a shell 1 and a light-emitting mechanism 2. The shell 1 is configured to accommodate an electronic device. A camera through hole 12 is defined on the shell 1. The camera through hole 12 corresponds to a camera position of an electronic device, which is convenient for the electronic device to use the camera for photography.

The shell 1 includes a bottom plate 11, and the bottom plate 11 is disposed on a back side of the shell 1. The light-emitting mechanism 2 is disposed in the shell 1. The light-emitting mechanism 2 includes a light source assembly 23, a battery 21 and an electric control module 22. The light source assembly 23 and the battery 21 are respectively electrically connected to the electric control module 22. The light source assembly 23 includes lamp beads 232 and a lamp plate 231. The lamp beads 232 are disposed on the lamp plate 231. A light-transmitting region 111 is disposed on the bottom plate 11, and the light-transmitting region 111 corresponds to a position of the lamp beads 232.

A plurality of the lamp beads 232 are disposed, and the plurality of lamp beads 232 are arranged in an array. A shape of the light-transmitting region 111 is adjusted according to an arrangement mode of the lamp beads 232. Specifically, the electric control module 22 is located at a side edge of the camera through hole 12 of the shell 1. The lamp beads 232 are disposed at a middle position of the shell 1. The battery 21 is disposed at a lower position of the shell 1. The light-transmitting region 111 is adopted by a light transmitting plate made of a high light projection material. The light transmitting plate may well diffuse light emitted by the lamp beads 232. The lamp beads 232 are combinations of high color rendering index (CRI) and RGB lamp beads and cooling and heating lamp beads. The high CRI and RGB lamp beads have better color rendering property, and when matched with the heating and cooling lamp beads, the high CRI and RGB lamp beads not only provide a professional white light illumination, but also adjust color and brightness of light according to requirements, and the high CRI and RGB lamp beads meet different types of light mode requirements of a user.

A wireless module 221 is disposed in the electric control module 22. The wireless module 221 is configured for being wirelessly connected with the electronic device. After the wireless module 221 is connected to the electronic device, an APP software for controlling the light supplementing lamp may be set, and the APP software is preset various modes of the light supplementing lamp. By means of the electronic device, a switch and/or a light-emitting mode and/or a light-emitting color temperature of the lamp beads 232 may be controlled, so that when the light supplementing lamp is used by the user, parameters of the light supplementing lamp are directly set on the electronic device. Specifically, the light-emitting mode includes a light-emitting color and a light-emitting brightness.

A PC protective sheet (not shown in the figure) is disposed on a surface of the lamp plate 231 and the battery 21, and the PC protective sheet is bonded and fixed through a back adhesive (not shown in the figure). The back adhesive is disposed to enable the lamp beads 232 to be in a sealed environment, so that the lamp beads 232 have good waterproof and dustproof effects, service life of the lamp beads 232 is prolonged, light emitted by the lamp beads is limited, and a shading effect is achieved.

A usage method is as follows: the electronic device is stored in the electronic device protective shell with light supplementing lamp. A Bluetooth of the electronic device is connected with the wireless module 221, so that the user directly adjusts the lamp beads 232 on the electronic device according to requirements.

The wireless module 221 is disposed on the electric control module 22 in the present disclosure, and the wireless module 221 is connected with the electronic device, so that the user directly controls the switch and/or the light-emitting mode and/or the light-emitting color temperature of the lamp beads 232 on the electronic device, the light supplementing lamp is controlled during photographing, and an experience feeling of operation of the user is greatly improved.

In the description and claims of the present disclosure, words “include/comprise” and “have/contain” and variations thereof are configured to specify a presence of stated features, values, steps or components, but do not preclude a presence or an addition of one or more other features, values, steps, components, or combinations thereof.

For clarity of illustration, some features of the present disclosure are described in different embodiments. However, the features may also be described in a single embodiment. Rather, some features of the present disclosure are only described in a single embodiment for a sake of brevity. However, the features may also be described in different embodiments alone or in any suitable combination of the different embodiments.

Above descriptions are only preferred embodiments of the present disclosure and are not intended to limit the present disclosure. Any modification, equivalent replacement and improvement made within the spirit and principle of the present disclosure shall be included in a protection scope of the present disclosure.

What is claimed is:

1. An electronic device protective shell with a light supplementing lamp, comprising:
a shell; and
a light-emitting mechanism;
wherein the shell is configured to accommodate an electronic device; the shell comprises a bottom plate, the bottom plate is disposed on a back side of the shell; the light-emitting mechanism comprises a light source assembly, a battery, and an electric control module, and the light-emitting mechanism is disposed in the shell; the light source assembly and the battery are respectively and electrically connected to the electric control module; the light source assembly comprises lamp beads and a lamp plate, and a part, corresponding to the lamp plate, of the bottom plate is a light-transmitting plate.

2. The electronic device protective shell with light supplementing lamp according to claim 1, wherein a PC protective sheet is disposed on a surface of the lamp plate and a surface of the battery, and the PC protective sheet is bonded and fixed through a back adhesive.

3. The electronic device protective shell with light supplementing lamp according to claim 1, wherein the lamp beads are combinations of high color rendering index (CRI) RGB lamp beads and cooling and heating lamp beads.

4. The electronic device protective shell with light supplementing lamp according to claim 1, wherein a wireless module is disposed in the electric control module, and the wireless module is configured to be wirelessly connected with the electronic device to control a switch and/or a light-emitting mode and/or a light-emitting color temperature of the lamp beads through the electronic device.

5. The electronic device protective shell with light supplementing lamp according to claim 4, wherein the light-emitting mode comprises a light-emitting color and a light-emitting brightness.

6. The electronic device protective shell with light supplementing lamp according to claim 1, wherein the electric control module is located on a side edge of a camera through hole of the shell, the lamp beads are disposed in a middle of the shell, and the battery is disposed at a lower position of the shell.

7. The electronic device protective shell with light supplementing lamp according to claim 1, wherein the lamp beads are arranged in a plurality of parallel arrays.
